(19) United States
(12) Patent Application Publication
(10) Pub. No.: US 2011/0273486 A1
(43) Pub. Date: Nov. 10, 2011

(54) FIELD SEQUENTIAL COLOR DISPLAY APPARATUS

(75) Inventor: Takaji Numao, Osaka (JP)

(73) Assignee: SHARP KABUSHIKI KAISHA, Osaka-shi, Osaka (JP)

(21) Appl. No.: 13/138,049

(22) PCT Filed: Feb. 8, 2010
(86) PCT No.: PCT/JP2010/051814

§ 371 Date: Jun. 28, 2011

(30) Foreign Application Priority Data
May 13, 2009 (JP) 2009-116761

(51) Int. Cl. G09G 5/10

(52) U.S. Cl. 345/690

(57) ABSTRACT

A backlight unit includes a plurality of light sources whose light-emitting colors can be controlled independently. Each light source is associated with any one of a plurality of areas which are obtained by dividing a display screen. A color signal processing unit determines a chromaticity distribution of a video signal in an area, determines, in color space, a region containing all color coordinates in the area, and determines a light-emitting color of a corresponding light source for each field based on the determined region, and determines a transmittance of a liquid crystal element for each field based on the video signal in the area and the determined light-emitting color. By this, the difference between a color to be displayed and a color actually displayed is reduced area by area, reducing color breakup occurring in a field sequential color system.

### TECHNICAL FIELD

The present invention relates to a display apparatus using a field sequential color system, and more particularly to a display apparatus including an area active backlight as a backlight and including matrix-type display elements as shutter elements.

### BACKGROUND ART

In recent years, due to global warming problems, there has been an increasing demand for power saving technology. The power consumption of liquid crystal televisions is also seen as an issue and thus there has also been a demand for a reduction in the power consumption of liquid crystal televisions. Components of a liquid crystal television that consume a large amount of power include a signal processing circuit, a backlight, a liquid crystal panel drive circuit, and the like. Of those components, the power consumption of the backlight accounts for more than half of the total power consumption of the liquid crystal television. Thus, a reduction in the power consumption of the backlight is particularly important.

As methods for reducing the power consumption of the backlight, there are considered a method for improving the light emission efficiency of the backlight itself and a method for improving the light use efficiency of a liquid crystal panel. In the following, the latter method is considered. The light use efficiency of a liquid crystal panel is determined by the light use efficiency of polarizing plates, the light use efficiency of color filters provided in the liquid crystal panel, and the aperture ratio of the liquid crystal panel. The light use efficiency of polarizing plates has improved by the order of 75% in recent years due to the development of a DBEF (Dual Brightness Enhancement Film: a selective reflection-type polarizing plate manufactured by 3M Company), etc. On the other hand, the light use efficiency of color filters is on the order of 30% and has not made much improvement. The aperture ratio of a TFT (Thin Film Transistor) liquid crystal panel is on the order of 60%. The aperture ratio is subjected to constraints on process conditions and thus has a low likelihood of future improvement.

From the above-described facts, it seems that a method for improving the light use efficiency of color filters is most effective to achieve a reduction in the power consumption of a liquid crystal television. However, color filters have the property of absorbing light in wavebands other than a specific waveband. Hence, when one pixel is formed by sub-pixels of three RGB colors and each sub-pixel is provided with a color filter that absorbs light of colors other than a selected color, the light use efficiency of color filters is only less than 40%. When color filters that reflect light of colors other than a selected color are used, such as holographic technology, the light use efficiency of color filters improves. However, this method has not been put into practical use due to the difficulty of manufacturing.

Hence, as a method for performing color display without using color filters, a field sequential color system is receiving attention. In the field sequential color system, one frame period is divided into, for example, three RGB fields, and a red image is displayed in the first field, a green image is displayed in the next field, and a blue image is displayed in the last field, whereby color display is performed. According to the field sequential color system, since color filters become unnecessary, the light use efficiency of a liquid crystal panel can be improved three times or more compared to a color filter system.

However, the field sequential color system has a problem of the occurrence of color breakup. FIG. 17 is a diagram showing the principle of occurrence of color breakup. In (a) of FIG. 17, a vertical axis represents time and a horizontal axis represents a position on a screen. In general, when an object moves on a display screen, the observer's line of sight follows the object and moves in a moving direction of the object. For example, in an example shown in FIG. 17, when a white object moves from the left to right on a display screen, the observer's line of sight moves in a diagonal arrow direction. On the other hand, when three RGB field images are extracted from video of the same moment, the positions of the objects in the respective field images are the same. Hence, as shown in (b) of FIG. 17, color breakup occurs in video seen on the retina.

For measures against color breakup, Patent Document 1 describes a method for extracting three RGB field images from videos of different moments (first method) (see FIG. 18). This method can reduce color breakup which occurs in video seen on the retina when the observer's line of sight follows an object and moves (see (b) of FIG. 18).

Patent Document 2 describes a method for adjusting the hue of each field (second method) (see FIGS. 19 and 20). In a display apparatus 90 shown in FIG. 19, an input signal analyzing unit 91 includes a pixel data analyzing unit 92 that analyzes pixel data included in an input video signal; and a basic color setting unit 93 that sets basic colors of three RGB fields based on results of the analysis. The basic color setting unit 93 obtains a triangle R′G′B′ containing all color coordinates, based on a chromaticity distribution of the input video signal shown in FIG. 20, and adjusts the light-emitting colors of the respective fields according to the color coordinates of the vertices R′, G′, and B′ of the triangle. A backlight 99 includes light sources of three RGB colors. The light emission intensity of each light source is controlled using a backlight driving unit 96, according to the light-emitting colors of the respective fields determined by the basic color setting unit 93. The transmittance of each pixel 98 included in a liquid crystal panel 97 is controlled using a pixel intensity control unit 95 to a level determined by a pixel intensity setting unit 94 included in the basic color setting unit 93. According to this method, by bringing the light-emitting color of each field close to the color coordinates of the pixels, color breakup can be reduced.

Patent Document 2 also describes a method for changing the number of color fields according to an input image (third method) (see FIG. 21). In this method, for example, as shown in FIG. 21, the number of basic colors is set to 2 when an input image A including light blue and purple is displayed, the number of basic colors is set to 3 when an input image B including light blue, purple, and white is displayed, and the number of basic colors is set to 4 when an input image C including light blue, purple, white, and red is displayed.

### PRIOR ART DOCUMENTS

### Patent Documents

[Patent Document 1] Japanese Patent Laid-Open Publication No. 2007-264211

[Patent Document 2] Japanese Patent Laid-Open Publication No. 2003-248462

### SUMMARY OF THE INVENTION

### Problems to be Solved by the Invention

However, with the above-described first to third methods, color breakup cannot be sufficiently prevented. In the first method, there is a problem that a focused point on a display screen varies depending on the observer. For example, when an observer focuses on a background but not on a moving object, the observer's line of sight does not move. Thus, the observer recognizes that an object with color breakup passes through the front of the background. In addition, since some of the colors of the background are lacking due to the moving object, color breakup occurs in that portion.

In the second method, there is a problem that the color coordinates of pixels of an input video signal are widely distributed in color space in practice. When the color coordinates are widely distributed in color space, the light-emitting color of each field becomes close to a normal light-emitting color, and thus, color breakup cannot be effectively reduced.

In the third method, there is a problem that an input image including only a few colors is a rare case. In the third method, when the number of colors included in an input image is increased, the length of one field is reduced and thus color breakup becomes less noticeable, but it does not mean that color breakup can be reduced further.

An object of the present invention is therefore to effectively reduce color breakup occurring in a field sequential color system.

### Means for Solving the Problems

According to a first aspect of the present invention, there is provided a display apparatus using a field sequential color system, the display apparatus including: a display panel including a plurality of shutter elements arranged in a matrix form; a backlight unit including a plurality of light sources whose light-emitting colors can be controlled independently; and a signal processing unit that determines, based on an input video signal, light-emitting colors of the light sources and transmittances of the shutter elements for each field, wherein each of the light sources is associated with any one of a plurality of areas which are obtained by dividing a display screen, and the signal processing unit determines a chromaticity distribution of a video signal in an area, determines, in color space, a region containing all color coordinates in the area, and determines a light-emitting color of a corresponding light source for each field based on the determined region, and determines transmittances of corresponding shutter elements for each field based on the video signal in the area and the determined light-emitting color.

According to a second aspect of the present invention, in the first aspect of the present invention, the signal processing unit divides one frame period into three fields, determines, in color space, a triangle region containing all of the color coordinates in the area based on the chromaticity distribution, and determines a light-emitting color of the corresponding light source for each field based on coordinates of vertices of the determined triangle region.

According to a third aspect of the present invention, in the first aspect of the present invention, the signal processing unit divides one frame period into four or more fields, determines, in color space, a polygonal region containing all of the color coordinates in the area based on the chromaticity distribution, and determines a light-emitting color of the corresponding light source for each field based on coordinates of vertices of the determined polygonal region.

According to a fourth aspect of the present invention, in the first aspect of the present invention, each light source includes a red light source, a green light source, and a blue light source whose light emission intensities can be controlled independently.

According to a fifth aspect of the present invention, in the fourth aspect of the present invention, based on a pixel value (R, G, B) of a video signal and light emission intensities (Ri, Gi, Bi) of the red light source, the green light source, and the blue light source for an i-th field (i is an integer between 1 and a predetermined value, inclusive), the signal processing unit determines a transmittance Ti of a corresponding shutter element for the i-th field so as to satisfy R=Σ(Ri×Ti), G=Σ(Gi×Ti), and B=Σ(Bi×Ti).

According to a sixth aspect of the present invention, in the first aspect of the present invention, the signal processing unit converts the video signal in the area into a u′v′ coordinate system and determines, in u′v′ color space, a region containing all color coordinates in the area.

According to a seventh aspect of the present invention, there is provided a display method using a field sequential color system, for a display apparatus having a display panel including a plurality of shutter elements arranged in a matrix form; and a backlight unit including a plurality of light sources whose light-emitting colors can be controlled independently, the method including the steps of: for each of a plurality of areas which are obtained by dividing a display screen, determining a chromaticity distribution of a video signal in the area; determining, in color space, a region containing all color coordinates in the area; determining a light-emitting color of a light source for each field based on the determined region, the light source being associated with the area; determining transmittances of corresponding shutter elements for each field, based on the video signal in the area and the determined light-emitting color; and driving the backlight unit by specifying the light-emitting colors of the light sources, and driving the display panel by specifying the transmittances of the shutter elements.

### Effect of the Invention

According to the first or seventh aspect of the present invention, when color display is performed using a field sequential color system, a light-emitting color of a light source for each field is determined based on a chromaticity distribution of a video signal in each of areas which are obtained by dividing a display screen, whereby the light-emitting color of the light source for each field can be brought close to a color included in a given portion of a field image. By this, the difference between a color to be displayed and a color actually displayed is reduced area by area, enabling to effectively reduce color breakup occurring in a field sequential color system. In addition, by using a field sequential color system, color filters become unnecessary, and thus, the light use efficiency of a display panel is improved, enabling to achieve a reduction in the power consumption of a backlight.

According to the second aspect of the present invention, when a field sequential color system where one frame period is divided into three fields is used, a triangle region containing all color coordinates in an area is determined in color space and a light-emitting color of a corresponding light source for each field is determined based on the coordinates of the vertices of the determined triangle region. By this, the difference between a color to be displayed and a color actually displayed is reduced area by area, enabling to effectively reduce color breakup. In addition, by using a minimum number of fields required to display arbitrary colors, a display apparatus can be configured easily.

According to the third aspect of the present invention, when a field sequential color system where one frame period is divided into four or more fields is used, a polygonal region containing all color coordinates in an area is determined in color space and a light-emitting color of a corresponding light source for each field is determined based on the coordinates of the vertices of the determined polygonal region. By this, the difference between a color to be displayed and a color actually displayed is reduced area by area, enabling to effectively reduce color breakup. In addition, by increasing the number of fields, the length of one field period is reduced, whereby the period during which color breakup occurs in a specific color is reduced, enabling to more effectively reduce color breakup.

According to the fourth aspect of the present invention, by using a red light source, a green light source, and a blue light source whose light emission intensities can be controlled independently, a backlight unit including a plurality of light sources whose light-emitting colors can be controlled independently can be configured easily.

According to the fifth aspect of the present invention, by determining a transmittance of a shutter element for each field such that a predetermined relationship is established between the RGB values of a video signal and the light emission intensities of three types of light sources for each field, color display can be performed properly based on an input video signal.

According to the sixth aspect of the present invention, by determining a light-emitting color of a light source for each field based on a region determined in a u′v′ color space which is close to human color perception, the difference between a color to be displayed and a color actually displayed is controlled to be perceived as a small difference by a human, enabling to effectively reduce color breakup.

### BRIEF DESCRIPTION OF THE DRAWINGS

FIG. 1 is a block diagram showing a configuration of a liquid crystal display apparatus according to a first embodiment of the present invention.

FIG. 2 is a circuit diagram of a liquid crystal panel included in the liquid crystal display apparatus shown in FIG. 1.

FIG. 3 is a side view of the liquid crystal panel included in the liquid crystal display apparatus shown in FIG. 1.

FIG. 4 is a diagram showing a configuration of a backlight unit included in the liquid crystal display apparatus shown in FIG. 1.

FIG. 5 is a block diagram showing a detail of a triple speed frame rate conversion unit included in the liquid crystal display apparatus shown in FIG. 1.

FIG. 6 is a flowchart showing a process of a color signal processing unit included in the liquid crystal display apparatus shown in FIG. 1.

FIG. 7 is a diagram showing an example of performing a process of converting an input video signal into a u′v′ coordinate system in the liquid crystal display apparatus shown in FIG. 1.

FIG. 8 is a diagram showing a chromaticity distribution determined by the liquid crystal display apparatus shown in FIG. 1.

FIG. 9 is a diagram showing color triangles obtained on an area-by-area basis by the liquid crystal display apparatus shown in FIG. 1.

FIG. 10 is a diagram showing an example of performing a process of determining light emission intensities of LEDs and transmittances of liquid crystal elements in the liquid crystal display apparatus shown in FIG. 1.

FIG. 11 is a diagram showing a color triangle obtained by a conventional method.

FIG. 12 is a block diagram showing a configuration of a liquid crystal display apparatus according to a second embodiment of the present invention.

FIG. 13 is a flowchart showing a process of a color signal processing unit included in the liquid crystal display apparatus shown in FIG. 12.

FIG. 14 is a diagram showing an example of performing a process of obtaining a color hexagon in the liquid crystal display apparatus shown in FIG. 12.

FIG. 15 is a diagram showing an example of performing a process of obtaining a color hexagon in the liquid crystal display apparatus shown in FIG. 12.

FIG. 16 is a diagram showing color hexagons obtained on an area-by-area basis by the liquid crystal display apparatus shown in FIG. 12.

FIG. 17 is a diagram showing the principle of occurrence of color breakup.

FIG. 18 is a diagram showing first conventional measures against color breakup.

FIG. 19 is a block diagram showing a configuration of a display apparatus that takes second conventional measures against color breakup.

FIG. 20 is a diagram showing a color triangle obtained by the second conventional measures against color breakup.

FIG. 21 is a diagram showing third conventional measures against color breakup.

### MODE FOR CARRYING OUT THE INVENTION

### First Embodiment

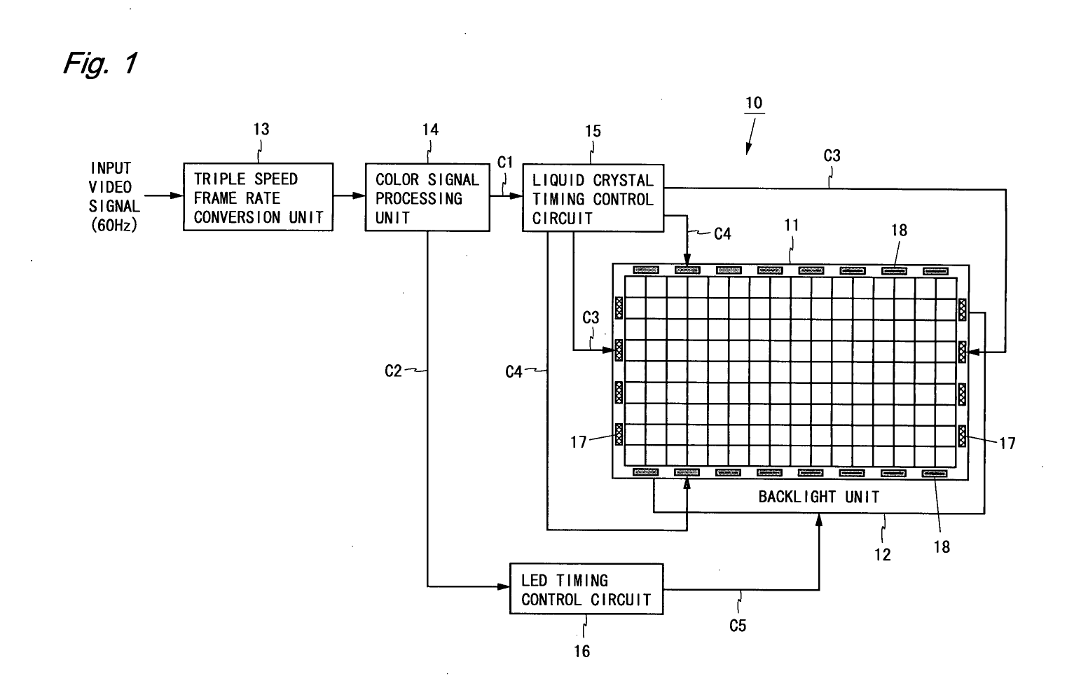

FIG. 1 is a block diagram showing a configuration of a liquid crystal display apparatus according to a first embodiment of the present invention. A liquid crystal display apparatus 10 shown in FIG. 1 includes a liquid crystal panel 11, a backlight unit 12, a triple speed frame rate conversion unit 13, a color signal processing unit 14, a liquid crystal timing control circuit 15, an LED timing control circuit 16, gate driver circuits 17, and source driver circuits 18. The liquid crystal display apparatus 10 performs color display using a field sequential color system where one frame period is divided into three RGB fields. In the following, it is assumed that a video signal with a frame rate of 60 Hz is inputted to the liquid crystal display apparatus 10.

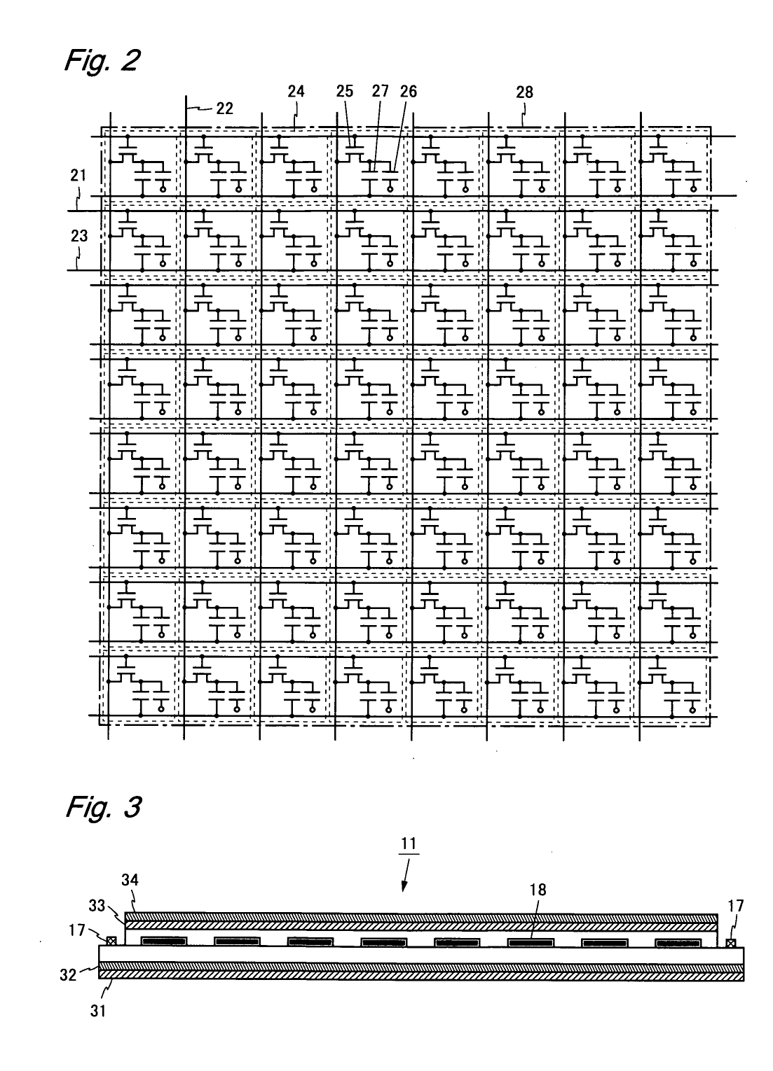

FIG. 2 is a circuit diagram of the liquid crystal panel 11. As shown in FIG. 2, the liquid crystal panel 11 includes a plurality of gate wiring lines 21, a plurality of source wiring lines 22, a plurality of auxiliary capacitance wiring lines 23, and a plurality of pixel circuits 24. The gate wiring lines 21 are arranged in parallel to one another, and the source wiring lines 22 are arranged in parallel to one another so as to intersect perpendicularly with the gate wiring lines 21. The auxiliary capacitance wiring lines 23 are arranged in parallel to the gate wiring lines 21. The gate driver circuits 17 are connected to the ends of the gate wiring lines 21, the source driver circuits 18 are connected to the ends of the source wiring lines 22, and auxiliary capacitance drive circuits (not shown) are connected to the ends of the auxiliary capacitance wiring lines 23.

The pixel circuits 24 are arranged at the respective points of intersection of the gate wiring lines 21 and the source wiring lines 22. Each pixel circuit 24 includes a TFT 25, a liquid crystal element 26, and an auxiliary capacitance 27, and corresponds to one pixel. The liquid crystal element 26 functions as a shutter element. As such, the liquid crystal panel 11 includes the plurality of shutter elements arranged in a matrix form.

FIG. 3 is a side view of the liquid crystal panel 11. As shown in FIG. 3, selective reflection-type polarizing plates 31 and 33 and selective absorption-type polarizing plates 32 and 34 are affixed to two sides of the liquid crystal panel 11. For the selective reflection-type polarizing plates 31 and 33, for example, DBEF series manufactured by 3M Company, etc., are used. The selective absorption-type polarizing plates 32 and 34 are normal polarizing plates. For the selective absorption-type polarizing plates 32 and 34, various polarizing plates, e.g., NPF series manufactured by Nitto Denko Corporation, etc., are used.

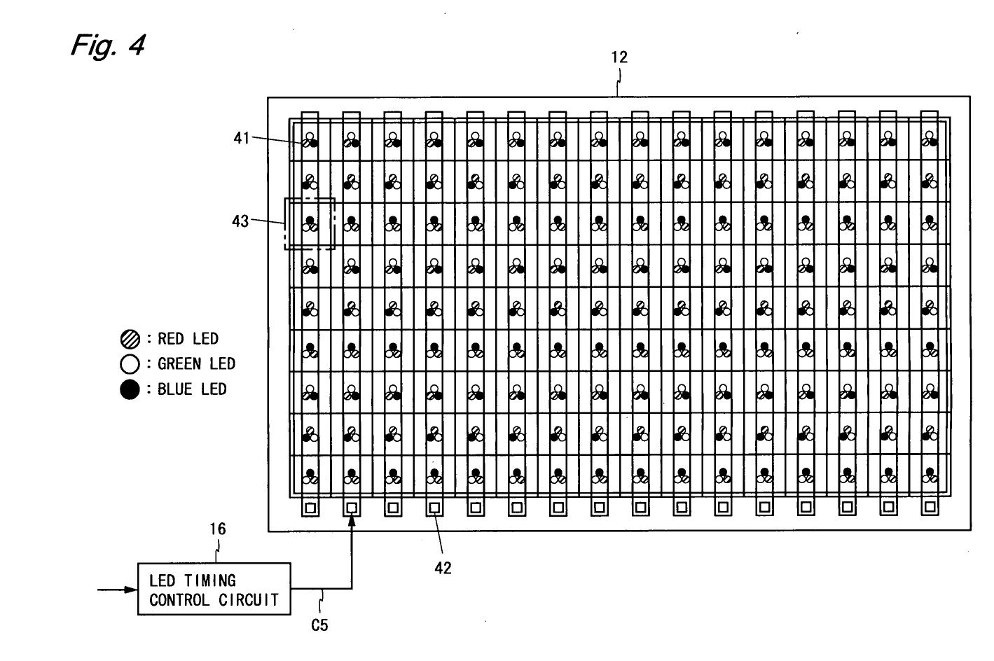

FIG. 4 is a diagram showing a configuration of the backlight unit 12. As shown in FIG. 4, the backlight unit 12 includes a plurality of light sources 41 arranged two-dimensionally; and a plurality of LED driver circuits 42. Each light source 41 includes a red LED, a green LED, and a blue LED. The LED driver circuits 42 individually control the light emission intensities of three types of LEDs included in the light sources 41. As such, the backlight unit 12 includes the plurality of light sources 41 whose light-emitting colors can be controlled independently.

A display screen of the liquid crystal display apparatus 10 is divided into a plurality of areas so as to be associated with the light sources 41 respectively. Each light source 41 is associated with a plurality of pixels in a corresponding area (a plurality of pixel circuits 24 in a corresponding area). For example, when the display screen is divided in units of (8×8) pixels, a dash-dotted line portion 28 shown in FIG. 2 and a dash-dotted line portion 43 shown in FIG. 4 correspond to one area. As such, each light source 41 included in the backlight unit 12 is associated with any one of a plurality of areas which are obtained by dividing the display screen.

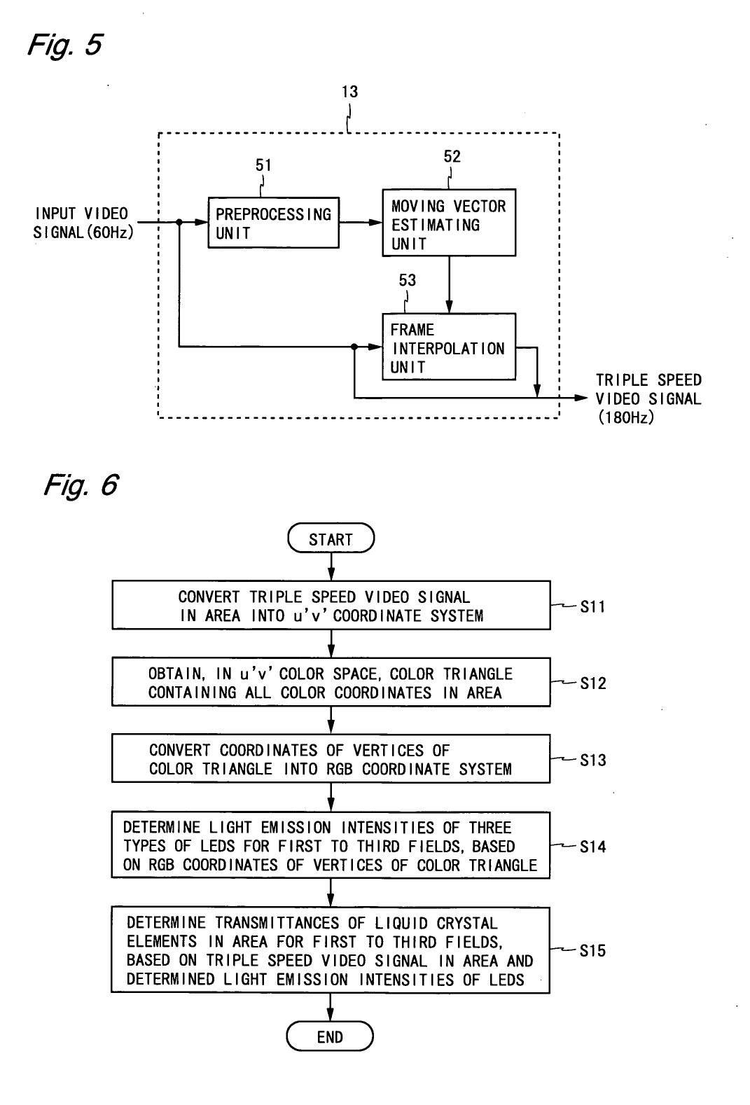

FIG. 5 is a block diagram showing a detail of the triple speed frame rate conversion unit 13. The triple speed frame rate conversion unit 13 generates a triple speed video signal (frame rate: 180 Hz) based on an input video signal (frame rate: 60 Hz). As shown in FIG. 5, the triple speed frame rate conversion unit 13 includes a preprocessing unit 51, a motion vector estimating unit 52, and a frame interpolation unit 53. The preprocessing unit 51 performs preprocessing, such as noise reduction, on an input video signal. The motion vector estimating unit 52 estimates a motion vector based on the preprocessed video signal. The frame interpolation unit 53 performs a frame interpolation process on an input video signal by referring to the motion vector determined by the motion vector estimating unit 52. By this, a triple speed video signal is generated. As such, the liquid crystal display apparatus 10 uses, as with the conventional first method, a method for extracting three field images from videos of different moments. Note that a detail of frame rate conversion is described in “A Development of Large-Screen Full HD LCD TV with Frame-Rate-Conversion Technology”, SID 07 DIGEST, pp. 1721-1724.

The color signal processing unit 14 generates a control signal C1 for the liquid crystal timing control circuit 15 and a control signal C2 for the LED timing control circuit 16, based on the triple speed video signal generated by the triple speed frame rate conversion unit 13. The control signal C1 specifies the transmittances of the liquid crystal elements 26 for first to third fields, and the control signal C2 specifies the light-emitting colors of the light sources 41 (the light emission intensities of three types of LEDs) for the first to third fields. The liquid crystal timing control circuit 15 generates a control signal C3 for the gate driver circuits 17 and a control signal C4 for the source driver circuits 18, based on the control signal C1. The gate driver circuits 17 drive the gate wiring lines 21 based on the control signal C3, and the source driver circuits 18 drive the source wiring lines 22 based on the control signal C4. The LED timing control circuit 16 generates a control signal C5 for the LED driver circuits 42, based on the control signal C2. The LED driver circuits 42 drive the light sources 41 based on the control signal C5. As such, the liquid crystal display apparatus 10 performs color display by displaying three field images based on an input video signal.

A detail of the color signal processing unit 14 will be described below. The color signal processing unit 14 determines, based on pixel values (R, G, B) of a triple speed video signal in an area, light emission intensities (R1, G1, B1), (R2, G2, B2), and (R3, G3, B3) of three types of LEDs for the first to third fields and transmittances T1 to T3 of liquid crystal elements 26 for the first to third fields. Note that in the following description, for simplification of drawings, it is assumed that the display screen is divided into four areas and each area includes four pixels.

FIG. 6 is a flowchart showing a process of the color signal processing unit 14. The color signal processing unit 14 performs the process shown in FIG. 6 on an area-by-area basis. The color signal processing unit 14 first converts a triple speed video signal in an area into a u′v′ coordinate system (step S11). Then, the color signal processing unit 14 obtains, in u′v′ color space, a color triangle that contains all color coordinates in the area which are determined in step S11 (step S12). The color signal processing unit 14 then converts the coordinates of the vertices of the color triangle into an RGB coordinate system (step S13). Then, the color signal processing unit 14 determines light emission intensities of three types of LEDS for the first to third fields, based on the RGB coordinates of the vertices of the color triangle (step S14). Then, the color signal processing unit 14 determines transmittances of liquid crystal elements 26 in the area for the first to third fields, based on the triple speed video signal in the area and the light emission intensities of the LEDs determined in step S14 (step S15). Details of steps S11 to S15 will be described below.

In step S11, the color signal processing unit 14 first converts the (R, G, B) values of a triple speed video signal in an area into (X, Y, Z) values using equations (1a) to (1c), and then converts the (X, Y, Z) values into (x, y, z) values using equations (2a) to (2c), and further converts the (x, y, z) values into (u′, v′) values using equations (3a) and (3b).

X=0.412453R+0.357580G+0.180423B (1a)

Y=0.212671R+0.715160G+0.072169B (1b)

Z=0.019334R+0.119193G+0.950227B (1c)

x=X/(X+Y+Z) (2a)

y=Y/(X+Y+Z) (2b)

z=Z/(X+Y+Z)=1-x-y (2c)

u′=4x/(x+15y+3z) (3a)

v′=9y/(x+15y+3z) (3b)

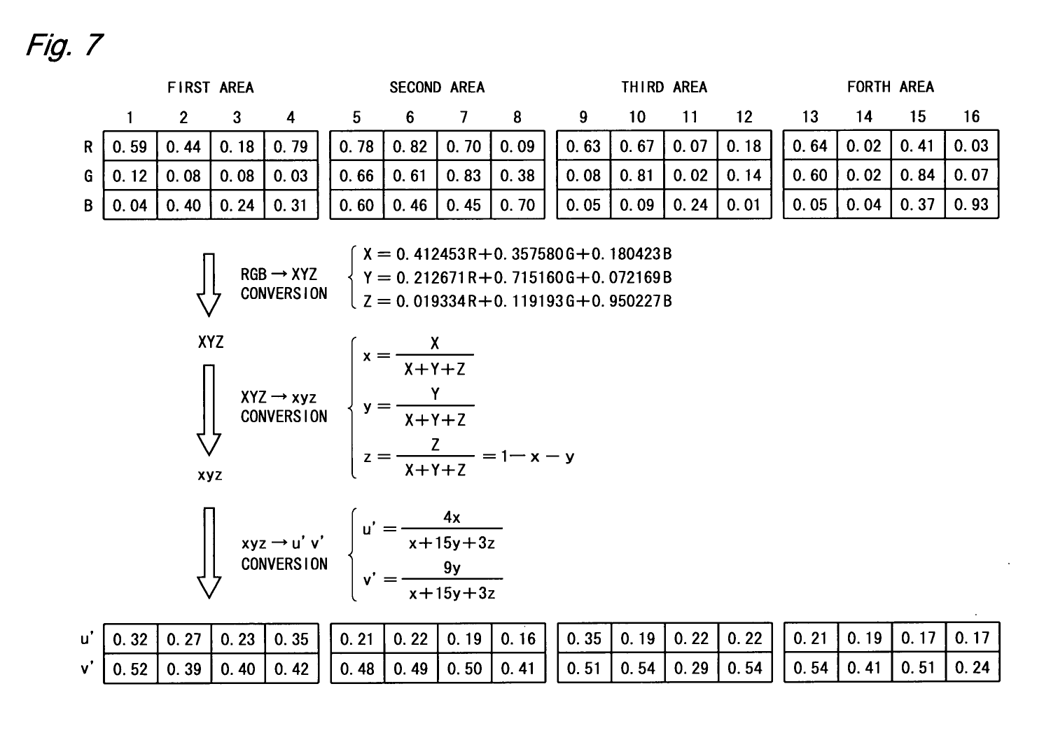

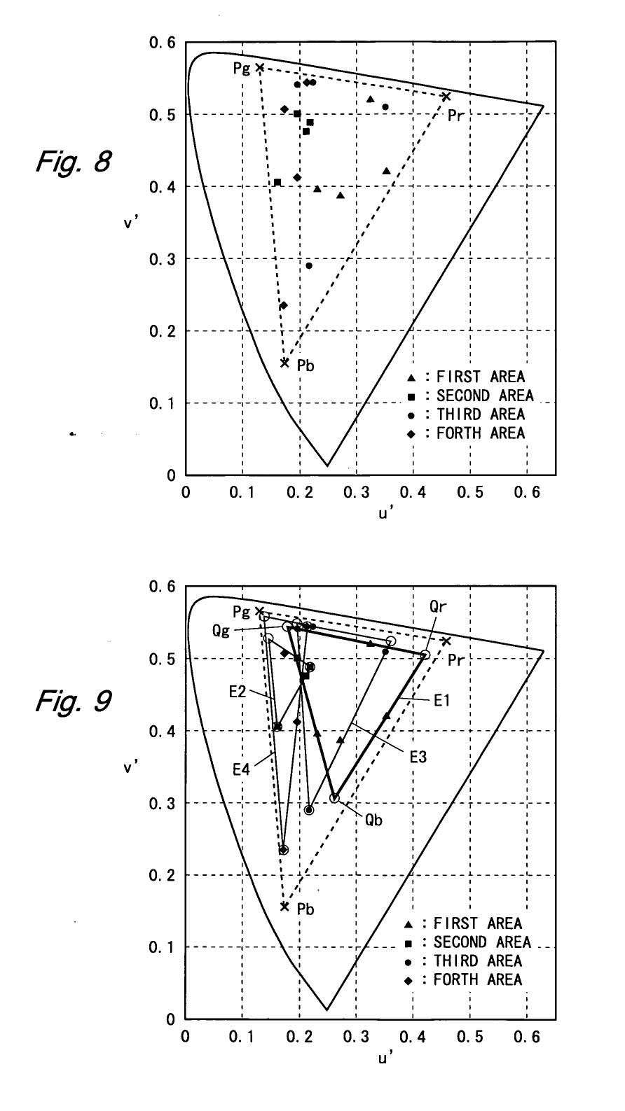

FIG. 7 is a diagram showing an example of performing step S11. 16 (R, G, B) values shown at the top in FIG. 7 are random values. These 16 (R, G, B) values are converted in step S11 into 16 (u′, v′) values, respectively, shown at the bottom in FIG. 7. When the obtained 16 (u′, v′) values are arranged in u′v′ color space, a chromaticity distribution shown in FIG. 8 is obtained. Note that in the drawing showing the color distribution, (u′, v′) values included in the same area are described using the same symbol. Three points Pr, Pg, and Pb are respectively color coordinates for when only a red LED, a green LED, and a blue LED are emitted, and a triangle PrPgPb represents a color reproduction range by three types of LEDs. The (u′, v′) values arranged in u′v′ color space are hereinafter referred to as “pixel chromaticity points”.

In step S12, the color signal processing unit 14 obtains, in u′v′ color space, a color triangle that contains all pixel chromaticity points in the area, by performing steps S120 to S129. Note that all or some of three vertices of the color triangle may overlap each other.

(Step S120) Of straight lines passing through the point Pr and any of pixel chromaticity points, a straight line closest to the point Pg is determined, and let the pixel chromaticity point at that time be Q1.

(Step S121) Of straight lines passing through the point Pg and any of pixel chromaticity points, a straight line closest to the point Pr is determined, and let the pixel chromaticity point that time be Q2.

(Step S122) If Q1≠Q2, then a straight line passing through the two points Q1 and Q2 is determined. If Q1=Q2, then a straight line that has the same inclination as a straight line passing through the two points Pr and Pg and that passes through the point Q1 is determined.

(Step S123) Of straight lines passing through the point Pg and any of pixel chromaticity points, a straight line closest to the point Pb is determined, and let the pixel chromaticity point at that time be Q3.

(Step S124) Of straight lines passing through the point Pb and any of pixel chromaticity points, a straight line closest to the point Pg is determined, and let the pixel chromaticity point at that time be Q4.

(Step S125) If Q3≠Q4, then a straight line passing through the two points Q3 and Q4 is determined. If Q3=Q4, then a straight line that has the same inclination as a straight line passing through the two points Pg and Pb and that passes through the point Q3 is determined.

(Step S126) Of straight lines passing through the point Pb and any of pixel chromaticity points, a straight line closest to the point Pr is determined, and let the pixel chromaticity point at that time be Q5.

(Step S127) Of straight lines passing through the point Pr and any of pixel chromaticity points, a straight line closest to the point Pb is determined, and let the pixel chromaticity point at that time be Q6.

(Step S128) If Q5≠Q6, then a straight line passing through the two points Q5 and Q6 is determined. If Q5=Q6, then a straight line that has the same inclination as a straight line passing through the two points Pb and Pr and that passes through the point Q5 is determined.

(Step S129) Points of intersection of the three straight lines determined in the above-described processes are determined. Of the three points of intersection, let the one closest to the point Pr be Qr, let the one closest to the point Pg be Qg, and let the one closest to the point Pb be Qb. A color triangle QrQgQb contains all pixel chromaticity points in the area.

When step S12 is performed on an area-by-area basis for the chromaticity distribution shown in FIG. 8, four color triangles E1 to E4 shown in FIG. 9 are obtained. Note that the color signal processing unit 14 may obtain a color triangle containing all pixel chromaticity points in an area, by methods other than that described above. In the following, it is assumed that the coordinates of the vertices of a color triangle QrQgQb are Qr(u1, v1), Qg(u2, v2), and Qb(u3, v3).

In step S13, the color signal processing unit 14 converts three (u′, v′) values into (R, G, B) values by performing conversion inverse to that in step S11. Note that, when converting an (x, y, z) value into an (X, Y, Z) value, an (X+Y+Z) value needs to be determined. Hence, the color signal processing unit 14 converts a (u′, v′) value into an (x, y, z) value and thereafter converts the (x, y, z) value into an (R, G, B) value using equations (4a) to (4c), supposing that X=x, Y=y, and Z=z.

R=3.240479x−1.537150y−0.498535z (4a)

G=−0.969256x+1.875991y+0.041556z (4b)

B=0.055648x−0.204043y+1.057311z (4c)

It is assumed that, in step S13, (u1, v1) is converted into (r1, g1, b1), (u2, v2) into (r2, g2, b2), and (u3, v3) into (r3, g3, b3). In addition, for the pixel values of the triple speed video signal in the area, let the highest value for a red component be Rm, let the highest value for a green component be Gm, and let the highest value for a blue component be Bm. For example, in a first area shown in FIG. 7, Rm=0.79, Gm=0.12, and Bm=0.40.

In step S14, the color signal processing unit 14 determines light emission intensities of three types of LEDs for the first to third fields by performing scaling using the highest values Rm, Gm, and Bm for the color components. Specifically, the color signal processing unit 14 determines light emission intensities (R1, G1, B1) of three types of LEDs for the first field using equations (5a) to (5c), determines light emission intensities (R2, G2, B2) of three types of LEDs for the second field using equations (6a) to (6c), and determines light emission intensities (R3, G3, B3) of three types of LEDs for the third field using equations (7a) to (7c).

R1=Rm (5a)

G1=Rm×g1/r1 (5b)

B1=Rm×b1/r1 (5c)

R2=Gm×r2/g2 (6a)

G2=Gm (6b)

B2=Gm×b2/g2 (6c)

R3=Bm×r3/b3 (7a)

G3=Bm×g3/b3 (7b)

B3=Bm (7c)

In step S15, the color signal processing unit 14 determines transmittances T1 to T3 of liquid crystal elements 26 for the first to third fields to satisfy equations (8a) to (8c), based on the light emission intensities (Ri, Gi, Bi) of three types of LEDs for the first to third fields which are determined in step S14 (i is an integer between 1 and 3, inclusive) and the pixel values (R, G, B) of the triple speed video signal in the area.

R=R1×T1+R2×T2+R3×T3 (8a)

G=G1×T1+G2×T2+G3×T3 (8b)

B=B1×T1+B2×T2+B3×T3 (8c)

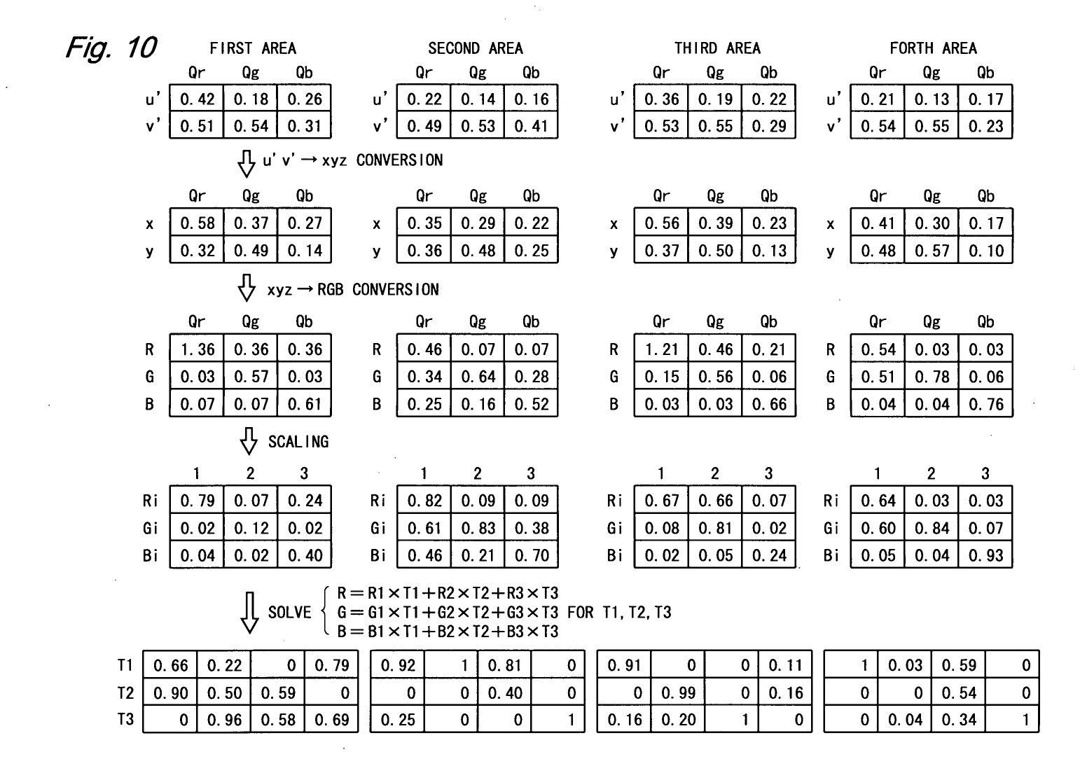

FIG. 10 is a diagram showing an example of performing steps S13 to S15. FIG. 10 shows the results of performing steps S13 to S15 for the chromaticity distribution shown in FIG. 8. For example, the light emission intensities of three types of LEDs included in a light source 41 in a first area are (0.79, 0.02, 0.04) for the first field, (0.07, 0.12, 0.02) for the second field, and (0.24, 0.02, 0.40) for the third field. The transmittances of the first liquid crystal element 26 are 0.66 for the first field, 0.90 for the second field, and 0 for the third field.

In the first field, the color signal processing unit 14 outputs a control signal C1 including transmittance T1 to the liquid crystal timing control circuit 15, and outputs a control signal C2 including light emission intensities (R1, G1, B1) to the LED timing control circuit 16. By this, in the first field, the light emission intensities of three types of LEDs included in the light sources 41 are (R1, G1, B1) and the transmittance of the liquid crystal element 26 included in the pixel circuit 24 is T1. Likewise, the color signal processing unit 14 outputs, in the second field, a control signal C1 including transmittance T2 and a control signal C2 including light emission intensities (R2, G2, B2) and outputs, in the third field, a control signal C1 including transmittance T3 and a control signal C2 including light emission intensities (R3, G3, B3). By this, in the second field, the light emission intensities of three types of LEDs are (R2, G2, B2) and the transmittance of the liquid crystal element 26 is T2. In the third field, the light emission intensities of three types of LEDs are (R3, G3, B3) and the transmittance of the liquid crystal element 26 is T3.

A color component of the luminance of a pixel is obtained by adding the products of each light emission intensity of an LED of the color and each transmittance of a liquid crystal element 26 for the first to third fields. Since the above equations (8a) to (8c) are established between the light emission intensities of LEDs and the transmittances of the liquid crystal element 26, the luminance of a pixel is (R, G, B). Therefore, according to the liquid crystal display apparatus 10, color display can be performed properly based on an input video signal, using a field sequential color system.

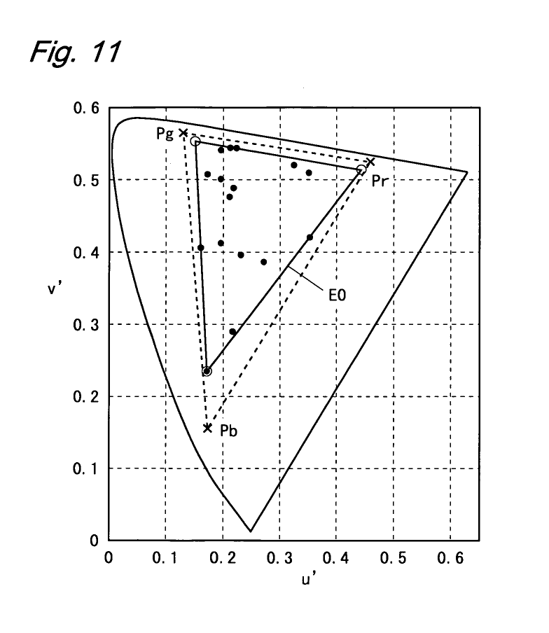

When a color triangle containing all pixel chromaticity points in the display screen is obtained for the chromaticity distribution shown in FIG. 8, a color triangle E0 shown in FIG. 11 is obtained. Color triangles E1 to E4 shown in FIG. 9 are all smaller than the color triangle E0 shown in FIG. 11. Hence, when comparing the case in which light-emitting colors of the light sources 41 for the first to third fields are determined based on the coordinates of the vertices of the color triangle E0 with the case in which the light-emitting colors are determined based on the coordinates of the vertices of the color triangles E1 to E4, the light-emitting colors of the light sources 41 are closer to colors included in the display screen in the latter than in the former. Thus, since the difference between a color to be displayed and a color actually displayed is smaller in the latter than in the former, color breakup occurring in a field sequential color system becomes less noticeable.

As described above, according to the liquid crystal display apparatus 10 according to the present embodiment, when color display is performed using a field sequential color system, a light-emitting color of a light source 41 for each field is determined based on a chromaticity distribution of a video signal in each of areas which are obtained by dividing the display screen, whereby the light-emitting color of the light source 41 for each field can be brought close to a color included in a given portion of a field image. By this, the difference between a color to be displayed and a color actually displayed is reduced area by area, enabling to effectively reduce color breakup occurring in a field sequential color system. In addition, by using a field sequential color system, color filters become unnecessary, and thus, the light use efficiency of the liquid crystal panel 11 is improved, enabling to achieve a reduction in the power consumption of the backlight unit 12.

The liquid crystal display apparatus 10 uses a field sequential color system where one frame period is divided into three fields. By thus using a minimum number of fields required to display arbitrary colors, the liquid crystal display apparatus 10 can be configured easily.

Each light source 41 includes a red LED, a green LED, and a blue LED whose light emission intensities can be controlled independently. By using three types of LEDs, the backlight unit 12 including a plurality of light sources 41 whose light-emitting colors can be controlled independently can be configured easily.

The color signal processing unit 14 determines transmittances of the liquid crystal elements 26 for the first to third fields such that equations (8a) to (8c) are established between the RGB values of a video signal and the light emission intensities of three types of LEDs for the first to third fields. By this, color display can be performed properly based on an input video signal.

The color signal processing unit 14 determines a light-emitting color of a light source 41 for each field based on a region determined in u′v′ color space which is close to human color perception. By this, the difference between a color to be displayed and a color actually displayed is controlled to be perceived as a small difference by a human, enabling to effectively reduce color breakup.

### Second Embodiment

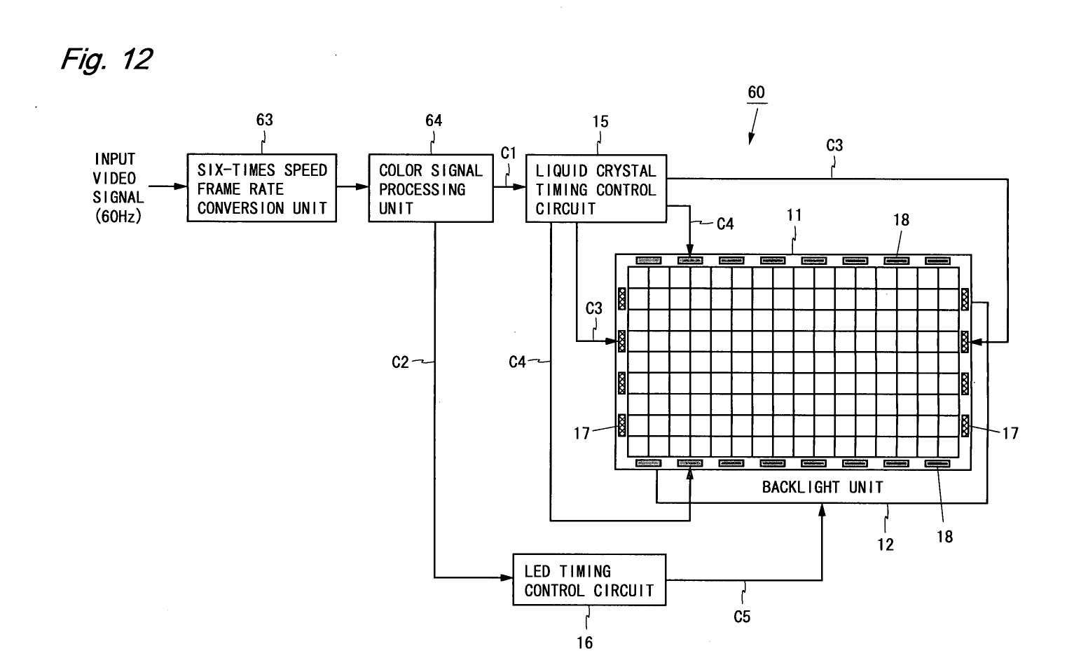

FIG. 12 is a block diagram showing a configuration of a liquid crystal display apparatus according to a second embodiment of the present invention. A liquid crystal display apparatus 60 shown in FIG. 12 is such that, in a liquid crystal display apparatus 10 according to the first embodiment, a triple speed frame rate conversion unit 13 is replaced by a six-times speed frame rate conversion unit 63 and a color signal processing unit 14 is replaced by a color signal processing unit 64. Other components are the same as those in the first embodiment except that the operating speed is high. The liquid crystal display apparatus 60 performs color display using a field sequential color system where one frame period is divided into six RGB fields.

The six-times speed frame rate conversion unit 63 has a similar configuration to that of the triple speed frame rate conversion unit 13 (see FIG. 5), and generates a six-times speed video signal (frame rate: 360 Hz) based on an input video signal (frame rate: 60 Hz).

The color signal processing unit 64 generates a control signal C1 for a liquid crystal timing control circuit 15 and a control signal C2 for an LED timing control circuit 16, based on the six-times speed video signal generated by the six-times speed frame rate conversion unit 63. Note that in the liquid crystal display apparatus 60 the control signal C1 specifies the transmittances of liquid crystal elements 26 for first to sixth fields, and the control signal C2 specifies the light-emitting colors of light sources 41 (the light emission intensities of three types of LEDs) for the first to sixth fields.

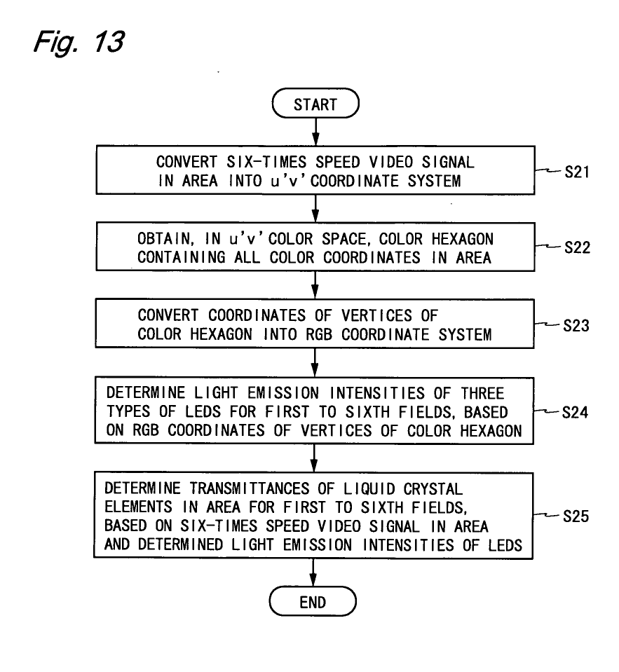

FIG. 13 is a flowchart showing a process of the color signal processing unit 64. The color signal processing unit 64 performs the process shown in FIG. 13 on an area-by-area basis. The color signal processing unit 64 first converts a six-times speed video signal in an area into a u′v′ coordinate system (step S21). Then, the color signal processing unit 64 obtains, in u′v′ color space, a color hexagon that contains all color coordinates in the area which are determined in step S21 (step S22). The color signal processing unit 64 then converts the coordinates of the vertices of the color hexagon into an RGB coordinate system (step S23). Then, the color signal processing unit 64 determines light emission intensities of three types of LEDs for the first to sixth fields, based on the RGB coordinates of the vertices of the color hexagon (step S24). Then, the color signal processing unit 64 determines transmittances of liquid crystal elements 26 in the area for the first to sixth fields, based on the six-times speed video signal in the area and the light emission intensities of the LEDs determined in step S24 (step S25). Details of steps S21 to S25 will be described below.

In step S21, as with step S11 according to the first embodiment, the color signal processing unit 64 converts the (R, G, B) values of a six-times speed video signal in an area into (u′, v′) values using equations (1a) to (1c), (2a) to (2c), and (3a) and (3b).

In step S22, the color signal processing unit 64 obtains, in u′v′ color space, a color hexagon that contains all pixel chromaticity points in the area, by performing steps S220 to S229. Note that all or some of six vertices of the color hexagon may overlap each other.

(Step S220) Of the pixel chromaticity points, a point Q1 with the largest u′ coordinate, a point Q2 with the largest v′ coordinate, a point Q3 with the smallest u′ coordinate, and a point Q4 with the smallest v′ coordinate are determined.

(Step S221) Of straight lines passing through the point Q1 and any of other pixel chromaticity points, let the inclination of a straight line with the largest v′-intercept be m1 and let the inclination of a straight line with the smallest v′-intercept be n1.

(Step S222) Of straight lines passing through the point Q2 and any of other pixel chromaticity points, let the inclination of a straight line with the largest u′-intercept be m2 and let the inclination of a straight line with the smallest u′-intercept be n2.

(Step S223) Of straight lines passing through the point Q3 and any of other pixel chromaticity points, let the inclination of a straight line with the largest v′-intercept be m3 and let the inclination of a straight line with the smallest v′-intercept be n3.

(Step S224) Of straight lines passing through the point Q4 and any of other pixel chromaticity points, let the inclination of a straight line with the largest u′-intercept be m4 and let the inclination of a straight line with the smallest u′-intercept be n4.

(Step S225) A point of intersection Q5 of the straight line with the inclination m1 passing through the point Q1 and the straight line with the inclination m2 passing through the point Q2 is determined.

(Step S226) A point of intersection Q6 of the straight line with the inclination n2 passing through the point Q2 and the straight line with the inclination n3 passing through the point Q3 is determined.

(Step S227) A point of intersection Q7 of the straight line with the inclination m3 passing through the point Q3 and the straight line with the inclination m4 passing through the point Q4 is determined.

(Step S228) A point of intersection Q8 of the straight line with the inclination n4 passing through the point Q4 and the straight line with the inclination n1 passing through the point Q1 is determined.

(Step S229) Six points are selected from among the eight points Q1 to Q8 such that they do not overlap as much as possible. Specifically, when all of the eight points do not overlap each other, six points Q1 to Q6 are selected. When there are seven points that do not overlap each other, six points other than one of the overlapping points and the point Q8 are selected. Note that, when the point Q8 overlaps any other point, six points Q1 to Q6 are selected. When there are five points or less that do not overlap each other, four points Q1 to Q4 are selected even if they overlap each other. A color hexagon obtained in step S229 contains all of the pixel chromaticity points in the area.

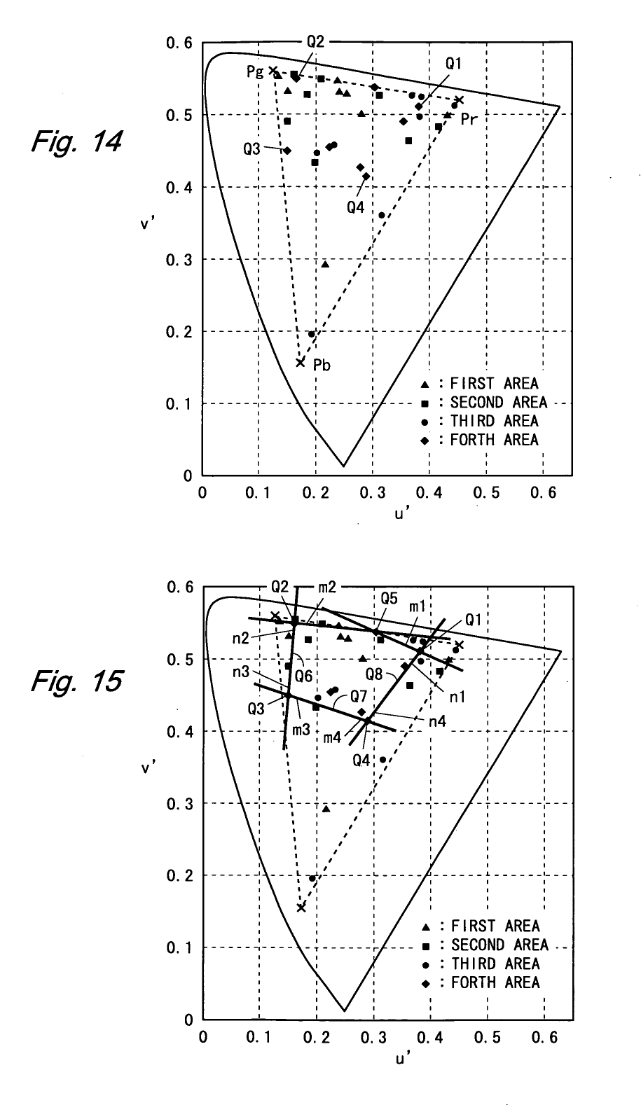

FIGS. 14 and 15 are diagrams showing examples of performing step S22. When step S220 is performed on pixel chromaticity points in a fourth area in a chromaticity distribution shown in FIG. 8, four points Q1 to Q4 shown in FIG. 14 are obtained. When steps S221 to S228 are further performed, straight lines and the points of intersection shown in FIG. 15 are obtained. A point Q5 shown in FIG. 15 is the point of intersection of a straight line with inclination m1 passing through the point Q1 and a straight line with inclination m2 passing through the point Q2. Since a straight line with inclination n2 passing through the point Q2 and a straight line with inclination n3 passing through the point Q3 coincide with each other, an arbitrary point on the straight lines is a point Q6. The same as that for the point Q6 also applies to two points Q7 and Q8.

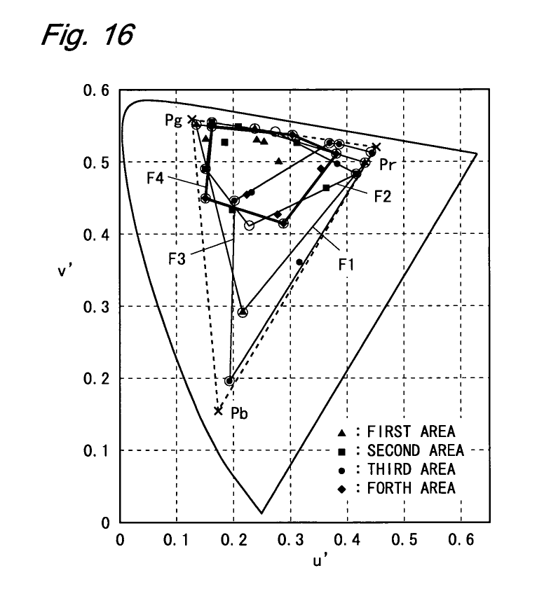

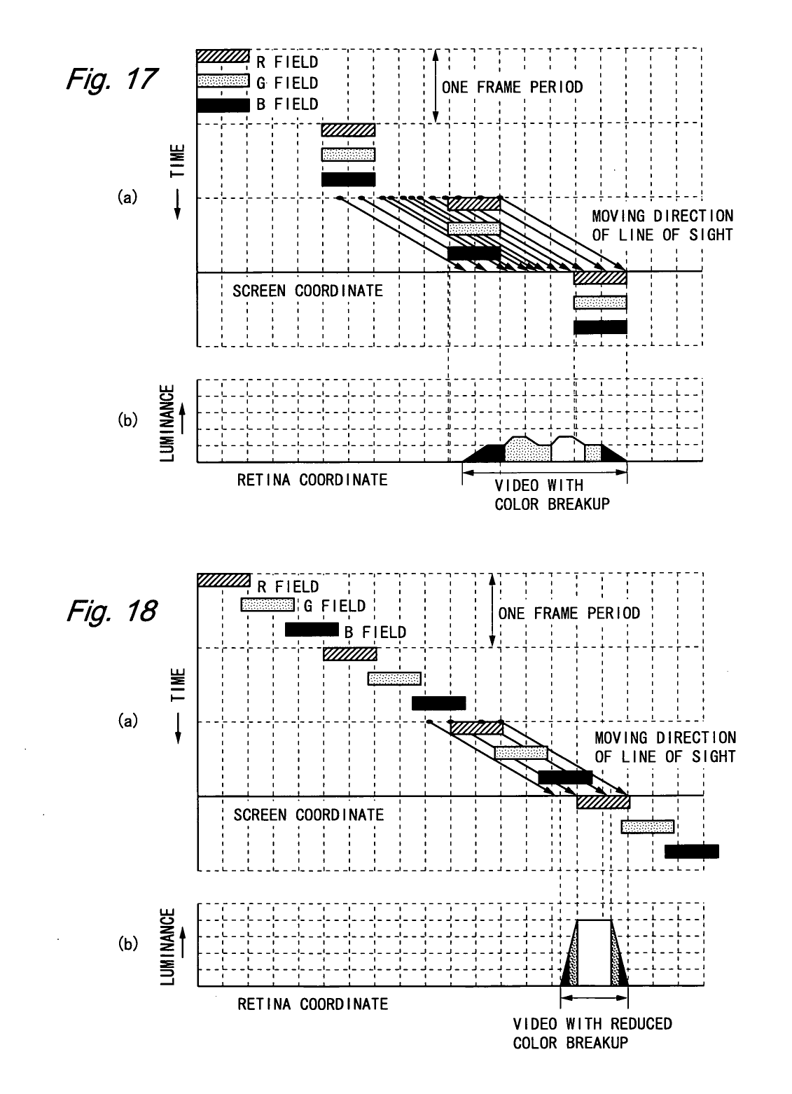

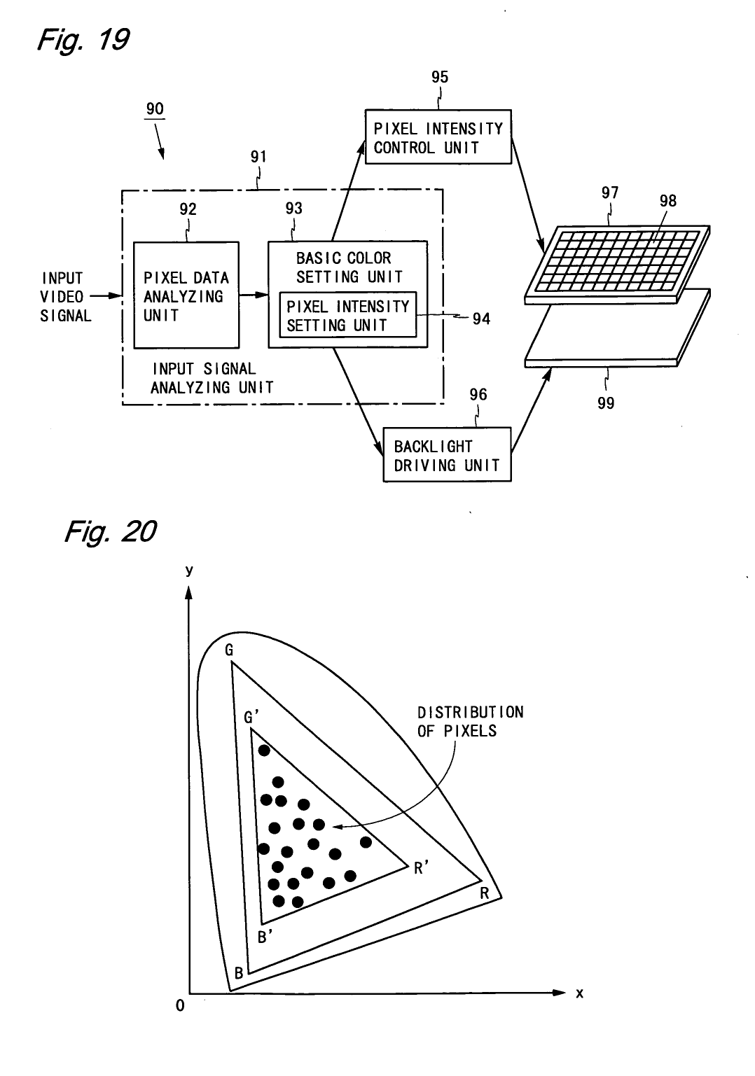

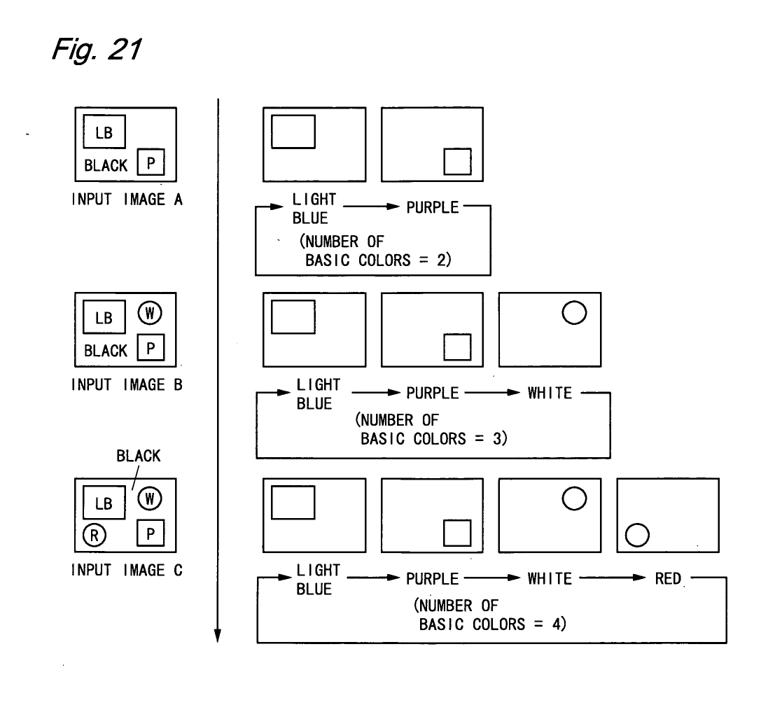

When step S22 is performed on an area-by-area basis for the chromaticity distribution shown in FIG. 8, four color hexagons F1 to F4 shown in FIG. 16 are obtained. Note that as with the first embodiment, the color signal processing unit 64 may obtain a color hexagon containing all pixel chromaticity points in an area, by methods other than that described above.

In step S23, as with step S13 according to the first embodiment, the color signal processing unit 64 converts six (u′, v′) values into (R, G, B) values by performing conversion inverse to that in step S11.

In step S24, as with step S14 according to the first embodiment, the color signal processing unit 64 determines light emission intensities (Rj, Gj, Bj) of three types of LEDs for the first to sixth fields (j is an integer between 1 and 6, inclusive) by performing scaling using equations (5a) to (5c), etc.

In step S25, the color signal processing unit 64 determines transmittances T1 to T6 of liquid crystal elements 26 for the first to sixth fields to satisfy equations (9a) to (9c), based on the light emission intensities (Rj, Gj, Bj) of three types of LEDs for the first to sixth fields which are determined in step S24 and the pixel values (R, G, B) of the six-times speed video signal in the area.

R=R1×T1+R2×T2+R3×T3+R4×T4+R5×T5+R6×T6 (9a)

G=G1×T1+G2×T2+G3×T3+G4×T4+G5×T5+G6×T6 (9b)

B=B1×T1+B2×T2+B3×T3+B4×T4+B5×T5+B6×T6 (9c)

In a j-th field, the color signal processing unit 64 outputs a control signal C1 including transmittance Tj to the liquid crystal timing control circuit 15, and outputs a control signal C2 including light emission intensities (Rj, Gj, Bj) to the LED timing control circuit 16. By this, in the j-th field, the light emission intensities of three types of LEDs included in the light sources 41 are (Rj, Gj, Bj) and the transmittance of the liquid crystal element 26 included in pixel circuit 24 is Tj. Since the above equations (9a) to (9c) are established between the light emission intensities of LEDs and the transmittances of a liquid crystal element 26, the luminance of a pixel is (R, G, B). Therefore, according to the liquid crystal display apparatus 60, color display can be performed properly based on an input video signal, using a field sequential color system.

According to the liquid crystal display apparatus 60 according to the present embodiment, as with the liquid crystal display apparatus 10 according to the first embodiment, the light-emitting color of a light source 41 for each field is brought close to a color included in a given portion of a field image, whereby the difference between a color to be displayed and a color actually displayed is reduced area by area, enabling to effectively reduce color breakup occurring in a field sequential color system. In addition, by increasing the number of fields, the length of one field period is reduced, whereby the period during which color breakup occurs in a specific color is reduced, enabling to more effectively reduce color breakup.

Note that, for the liquid crystal display apparatuses 10 and 60 according to the first and second embodiments of the present invention, the following variants can be configured. In the above description, the color signal processing unit 14 and 64 converts a video signal into a u′v′ coordinate system and obtains a color triangle or a color hexagon in u′v′ color space. Instead of this, the color signal processing unit 14 and 64 may convert a video signal into an xy coordinate system and obtain a color triangle or a color hexagon in xy color space.

The liquid crystal display apparatus 10 according to the first embodiment includes the triple speed frame rate conversion unit 13, and the liquid crystal display apparatus 60 according to the second embodiment includes the six-times speed frame rate conversion unit 63. Instead of this, a liquid crystal display apparatus of the present invention may include an m-times speed frame rate conversion unit (m is an integer greater than or equal to 4). When m is 4 or more, even if, for example, the frame rate of an input video signal is 60 Hz, the frame cycle is more than 80 Hz. By this, flicker can be made less noticeable. In addition, display apparatuses other than liquid crystal display apparatuses can also be configured by the above-described methods.

As described above, according to display apparatuses of the present invention, a light-emitting color of a light source for each field is determined based on a chromaticity distribution of a video signal in each of areas which are obtained by dividing a display screen, whereby the difference between a color to be displayed and a color actually displayed is reduced area by area, enabling to effectively reduce color breakup occurring in a field sequential color system.

### INDUSTRIAL APPLICABILITY

Display apparatuses of the present invention provide the effect of the ability to effectively reduce color breakup, and thus can be used as various display apparatuses using a field sequential color system, such as liquid crystal display apparatuses using a field sequential color system.

### DESCRIPTION OF REFERENCE NUMERALS

10 and 60: LIQUID CRYSTAL DISPLAY APPARATUS

11: LIQUID CRYSTAL PANEL

12: BACKLIGHT UNIT

13: TRIPLE SPEED FRAME RATE CONVERSION UNIT

14 and 64: COLOR SIGNAL PROCESSING UNIT

15: LIQUID CRYSTAL TIMING CONTROL CIRCUIT

16: LED TIMING CONTROL CIRCUIT

17: GATE DRIVER CIRCUIT

18: SOURCE DRIVER CIRCUIT

21: GATE WIRING LINE

22: SOURCE WIRING LINE

23: AUXILIARY CAPACITANCE WIRING LINE

24: PIXEL CIRCUIT

25: TFT

26: LIQUID CRYSTAL ELEMENT

27: AUXILIARY CAPACITANCE

28 and 43: AREA

31 and 33: SELECTIVE REFLECTION-TYPE POLARIZING PLATE

32 and 34: SELECTIVE ABSORPTION-TYPE POLARIZING PLATE

41: LIGHT SOURCE

42: LED DRIVER CIRCUIT

51: PREPROCESSING UNIT

52: MOTION VECTOR ESTIMATING UNIT

53: FRAME INTERPOLATION UNIT

63: SIX-TIMES SPEED FRAME RATE CONVERSION UNIT

1. A display apparatus using a field sequential color system, the display apparatus comprising:
a display panel including a plurality of shutter elements arranged in a matrix form;
a backlight unit including a plurality of light sources whose light-emitting colors can be controlled independently; and
a signal processing unit that determines, based on an input video signal, light-emitting colors of the light sources and transmittances of the shutter elements for each field, wherein
each of the light sources is associated with any one of a plurality of areas which are obtained by dividing a display screen, and
the signal processing unit determines a chromaticity distribution of a video signal in an area, determines, in color space, a region containing all color coordinates in the area, and determines a light-emitting color of a corresponding light source for each field based on the determined region, and determines transmittances of corresponding shutter elements for each field based on the video signal in the area and the determined light-emitting color.

2. The display apparatus according to claim 1, wherein the signal processing unit divides one frame period into three fields, determines, in color space, a triangle region containing all of the color coordinates in the area based on the chromaticity distribution, and determines a light-emitting color of the corresponding light source for each field based on coordinates of vertices of the determined triangle region.

3. The display apparatus according to claim 1, wherein the signal processing unit divides one frame period into four or more fields, determines, in color space, a polygonal region containing all of the color coordinates in the area based on the chromaticity distribution, and determines a light-emitting color of the corresponding light source for each field based on coordinates of vertices of the determined polygonal region.

4. The display apparatus according to claim 1, wherein each light source includes a red light source, a green light source, and a blue light source whose light emission intensities can be controlled independently.

5. The display apparatus according to claim 4, wherein based on a pixel value (R, G, B) of a video signal and light emission intensities (Ri, Gi, Bi) of the red light source, the green light source, and the blue light source for an i-th field (i is an integer between 1 and a predetermined value, inclusive), the signal processing unit determines a transmittance Ti of a corresponding shutter element for the i-th field so as to satisfy R=Σ(Ri×Ti), G=Σ(Gi×Ti), and B=Σ(Bi×Ti).

6. The display apparatus according to claim 1, wherein the signal processing unit converts the video signal in the area into a u′v′ coordinate system and determines, in u′v′ color space, a region containing all color coordinates in the area.

7. A display method using a field sequential color system, for a display apparatus having a display panel including a plurality of shutter elements arranged in a matrix form; and
a backlight unit including a plurality of light sources whose light-emitting colors can be controlled independently, the method comprising the steps of:
for each of a plurality of areas which are obtained by dividing a display screen, determining a chromaticity distribution of a video signal in the area;
determining, in color space, a region containing all color coordinates in the area;
determining a light-emitting color of a light source for each field based on the determined region, the light source being associated with the area;
determining transmittances of corresponding shutter elements for each field, based on the video signal in the area and the determined light-emitting color; and
driving the backlight unit by specifying the light-emitting colors of the light sources, and driving the display panel by specifying the transmittances of the shutter elements.
